(19) United States
(12) Patent Application Publication
(10) Pub. No.: US 2013/0148343 A1
(43) Pub. Date: Jun. 13, 2013

(54) COMPACT LED LAMP

(71) Applicants: Marek Kowarz, Henrietta, NY (US); Felipe Leon, Farmington, NY (US)

(72) Inventors: Marek Kowarz, Henrietta, NY (US); Felipe Leon, Farmington, NY (US)

(21) Appl. No.: 13/313,156

(22) Filed: Dec. 7, 2011

(51) Int. Cl. F21V 9/00; F21V 29/00; F21V 21/00

(52) U.S. Cl. 362/231; 362/249.01

(57) ABSTRACT

The invention provides an illumination assembly and an illumination assembly based lamp. The illumination assembly includes a substrate that has a plurality of light emitting areas, such that each of the light emitting area includes a group of two or more semiconductor dies that are directly mounted on the substrate. Further, a light emitting area is separated by a first distance from another light emitting area and each semiconductor die in a light emitting area is separated by a second distance from another semiconductor die in the same light emitting area, such that the first distance is substantially greater than the second distance. Furthermore, the illumination assembly also includes a single piece optic element disposed over the plurality of light emitting areas, such that the single piece optic element is configured to direct light emitted from all the light emitting areas in a cone of light.

### FIELD OF INVENTION

The invention disclosed herein relates, in general, to a lighting apparatus. More specifically, the invention relates to a compact lighting module having multiple light emitting areas.

### BACKGROUND

With increase in costs of energy and reduction in cost of producing LEDs, LED lighting devices are increasingly being viewed to as a viable alternative to more conventional incandescent systems. Consequently, use of LED lamps and luminaires is increasing primarily due to high energy efficiency.

For high-brightness applications requiring hundreds of lumens or sometimes thousands of lumens, a conventional LED lamp often includes multiple LEDs on a substrate and an optic element enclosed in an enclosure. The optic element may be suitably shaped for scattering or directing the light emitted from multiple LEDs to desired areas. However, a large number of LEDs are often required in a lamp to provide required intensity of lighting.

In an attempt to provide required intensity US20100117099 Al discloses multichip module having multiple light emitting devices such as LEDs and a reflective layer that partially covers the conductive layer. Further, US20100117099A1 discloses a multichip light emitting module having plurality of LED dies or chips mounted over a substrate and a secondary lens over the lens or optics to produce a desired beam shape. US20070030676 A1 discloses a light-emitting module having multiple light-emitting devices i.e. LEDs arranged on a substrate, and plurality of packages enclosing each multiple light-emitting devices. US20110063837 A1 also discloses a mounting arrangement for a multi chip LED module with a single large reflective mirror that provides beam shaping.

These devices are generally insufficient to handle necessary thermal management, high-brightness, directionality and form factor in multiple LEDs based illumination assemblies, especially those intended for high-brightness flood or spot light applications. Moreover, when configured for such applications, these devices have large optic elements, making it difficult to adhere to existing lamp standards, such as ANSI C78.21-2003 (American National Standards for Electric Lamps—PAR and R Shapes, approved Oct. 30, 2003), and thus do not fit into existing fixtures, have low aesthetic value and are difficult to handle. Further, these factors adversely impact marketability and increase cost of production.

Accordingly, in light of the above discussion, there is a need of a compact, high intensity, high efficiency and low cost LED illumination assembly design.

### SUMMARY

In accordance with an embodiment of the present invention, an illumination assembly is provided. The illumination assembly includes a substrate that has a plurality of light emitting areas. Each of the plurality of light emitting areas includes a group of two or more semiconductor dies that are directly mounted on the substrate. Further, a light emitting area is separated by a first distance from another light emitting area and each semiconductor die in a light emitting area is separated by a second distance from an adjacent semiconductor die in the same light emitting area, such that the first distance is substantially greater than the second distance. Further, the illumination assembly also includes a single piece optic element disposed over the plurality of light emitting areas, such that the single piece optic element is configured to direct light emitted from all the light emitting areas in a cone of light.

In accordance with some embodiments of the present invention, an illumination assembly is provided with a substrate having a plurality of light emitting areas on the substrate. Each light emitting area is separated from other by at least a first distance. Further, each light emitting area includes one or more semiconductor dies directly mounted on the substrate. Also, each semiconductor die in a light emitting area is separated from an adjacent semiconductor die in the same light emitting area by a second distance, such that the first distance is substantially greater than the second distance. Furthermore, the illumination assembly also includes a single piece optic element disposed over the plurality of light emitting areas, and the single piece optic element is configured to direct light emitted from light emitting areas in a cone of light. Also, according to the invention the presence of the plurality of light emitting areas enables a reduction in thermal resistance and a height of the single piece optic element.

In some embodiments of the present invention, the illumination assembly includes a phosphor layer placed over at least the semiconductor dies.

In some embodiments, the first distance between each light emitting area is greater than 1.5 times of a diameter of the light emitting areas and is less than 6 times of diameter of the light emitting areas.

In some embodiments, the second distance between the semiconductor dies in the same light source is from 1 mm to 5 mm.

In some embodiments, the height of the single piece optic element is inversely related to a square root of a number of the light emitting areas. Further, the single piece optic element is formed by molding process.

In some embodiments, the light emitted by each light emitting area may be of different colors.

In some embodiments, the substrate is made of a material having a high thermal conductivity.

In some embodiments, the illumination assembly is encapsulated by a transparent window issubstantially placed over the illumination assembly.

In some embodiments, the single piece optic element includes plurality of light-directing sections. The plurality of light-directing sections has one-to-one correspondence with the light emitting areas.

In some embodiments, the cone of light is substantially rotationally symmetric about an axis of the cone and has a cone angle of less than 70 degrees full-width half-maximum.

In some embodiments of present invention, the illumination assembly includes at least 2 and at most 7 light emitting areas. The light emitting areas can be arranged to form a polygonal array for example: triangular, rectangular or hexagonal.

In some embodiments, the substrate is formed from a single metal plate and includes conducting traces for providing electrical current to the semiconductor dies.

In some embodiments, a lamp is provided. The lamp includes a substrate having a plurality of light emitting areas disposed on the substrate. Each light emitting area is separated from other by at least a first distance. Further, each light emitting area includes one or more semiconductor dies directly mounted on the substrate. Also, each semiconductor die is separated from an adjacent semiconductor die in the same light emitting area by a second distance, such that the first distance is substantially greater than the second distance. Furthermore, the lamp also includes a single piece optic element covering the plurality of light emitting areas, and the single piece optic element is configured to direct light emitted from light emitting areas in a cone of light. Also, according to the invention the presence of the plurality of light emitting a reason the single substrate enables a reduction in thermal resistance and a height of the single piece optic element. Further a current driver is connected to a substrate for providing a flow of current to semiconductor dies. Also, the lamp includes a heat sink connected to the current driver for dissipating heat.

### BRIEF DESCRIPTION OF DRAWINGS

The features of the present invention, which are believed to be novel, are set forth with particularity in the appended claims. The invention may best be understood by reference to the following description, taken in conjunction with the accompanying drawings. These drawings and the associated description are provided to illustrate some embodiments of the invention, and not to limit the scope of the invention.

FIG. 1 (Prior Art) is a diagrammatic illustrations of a top view of a conventional illumination assembly with a single light emitting area, in accordance with the state of the art prior to the present invention (i.e. prior art);

FIG. 2 (Prior Art) is a diagrammatic illustrations of a side view of a conventional illumination assembly with a single light emitting area, in accordance with the state of art prior to the present invention (i.e. prior art);

FIGS. 3a, 3b, 3c and 3d are diagrammatic illustrations of an arrangement of semiconductor dies of an illumination assembly with multiple light emitting areas, an enlarged view of a light emitting area, a top view of an illumination assembly with multiple light emitting areas and a side view of the illumination assembly, respectively, in accordance with an embodiment of the present invention;

FIG. 4 is a diagrammatic illustration of an arrangement of semiconductor dies in an illumination assembly with continuous phosphor region in accordance with an exemplary embodiment of the present invention;

FIG. 5 is a diagrammatic illustration of an arrangement of semiconductor dies in an exemplary illumination assembly with hexagonal substrate and seven light emitting areas in accordance with an exemplary embodiment of the present invention;

FIGS. 6a and 6b are diagrammatic illustration of a top view and a side view, respectively, of an illumination assembly, in accordance with an embodiment of the present invention;

FIG. 7 is a diagrammatic illustration of various components of a semiconductor die-based lamp in accordance with an embodiment of the present invention; and

FIG. 8 is a diagrammatic illustration of a stack of layers in an illumination assembly, in accordance with an embodiment of the present invention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION

Before describing the present invention in detail, it should be observed that the present invention utilizes a combination of apparatus components related to an illumination assembly and a lamp based on the illumination assembly. Accordingly the apparatus components have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

A light emitting diode (LED) is a small-sized semiconductor light source capable of transforming electric power into optical power with high efficiency. The LED is mainly composed of a semiconductor p-n junction structure. When a potential is applied to the p-n junction structure, electrons and holes are driven by the potential toward the p-n junction where they combine to release photons. An exemplary LED, as known in the state of the art includes a substrate, an n-type semiconductor layer, a first electrical contact attached to the n-type semiconductor layer, an optional active layer, a p-type semiconductor layer, and a second electrical contact attached to the p-type semiconductor layer.

The n-type semiconductor layer is adjacent to the p-type semiconductor layer, with electrical contacts on each end and the active layer sandwiched in between. When a voltage is applied across the first electrical contact and the second electrical contact, electrons move from the n-type semiconductor to the p-type semiconductor. Similarly, holes move in the reverse direction leading to current flow across the LED, i.e. negative electrons flow in one direction and holes in opposite direction. The holes exist at a lower energy level than free electrons, therefore, when the free electrons fall into the holes they lose energy and this energy is emitted in the form of a photon.

### Exemplary Prior Art

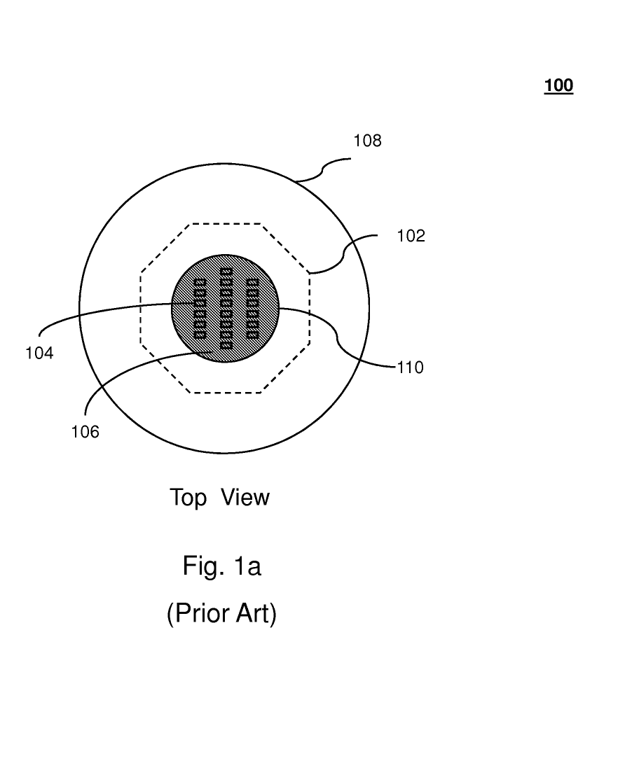

In FIG. 1, there is shown a diagrammatic illustration of a top view of a prior art LED illumination assembly 100. The LED illumination assembly 100 is shown to include a substrate 102, multiple Light Emitting Diodes (LEDs) 104, a phosphor layer 106 (shown in grey color) a single optic element 108 and a single light emitting area 110. The substrate 102 provides rigidity to the LED illumination assembly 100, and also acts to provide electrical connections to the LEDs 104. The LED illumination assembly 100 also includes the single light emitting area 110 having the multiple LEDs 104. The phosphor layer 106 is spread over the single light emitting area 110. In another embodiment, the phosphor layer 106 can be spread over each of the multiple LEDs 104. The phosphor layer 106 is provided to enable wavelength conversion of the light being emitted by the single light emitting area 110. Generally, the LEDs 104 emit blue light and the phosphor layer 106 converts a portion of the blue emitted light to a broad band of wavelengths near a yellow portion of a visible spectrum. When a combination of wavelengths including unconverted blue light along with yellow phosphor emission, passes through the phosphor layer 106, the combination is perceived as white. Alternatively, the LEDs 104 may be appropriately selected to provide any desired color of light or RGB LEDs may be used to provide white light without use of a phosphor. The optic element 108 functions to converge and direct rays of light emitted from the single light emitting area 110 in a predetermined angular cone (or in a desired angular profile). The optic element 108 may be reflective, refractive or a combination of both. Further, the shape of the optic element 108 is usually parabolic, concave or bowl shaped.

As the diameter of the light emitting area increases the corresponding height of the optic element will also increase to maintain intensity distribution of illumination. For example, a flood light with an angular intensity distribution of approximately 30 degrees full-width at half-maximum (FWHM) can be designed with a light emitting area that is approximately 28 mm in diameter and a reflective minor optic element that is approximately 38 mm in height and approximately 70 mm in maximum diameter. However, the large height and total volume occupied by the optic element is undesirable in many cases, particularly when configured in a replacement lamp that also needs to contain an electrical drive circuit and a substantial heat sink for heat dissipation.

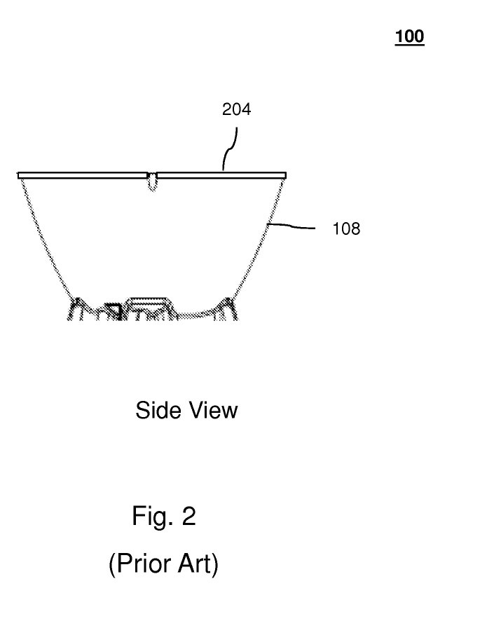

Moving on to FIG. 2, a side view of the LED illumination assembly 100 is shown. The LED illumination assembly 100 shows the single optic element 108 placed over the substrate 102 (as described above in FIG. 1). In this prior art example, the single optic element 108 that shapes the light distribution is a curved reflective mirror. The substrate 102 includes the single light emitting area 110 having multiple LEDs 104 (as described above in FIG. 1). Further an optional transparent window 204 made of plastic or glass is placed over the single optic element 108 to protect the single optic element from the environment, for example, dust, rain, finger touches and the like.

As noted earlier, the height and overall profile of the optic element 108 to be placed over the single light emitting area 110 may be scaled with the diameter of the single light emitting area 110 while providing a similar angular light distribution, for example, if diameter of the single light emitting area 108 increases, the height of the optic element 108 increases and, conversely, if the diameter of the single light emitting area 110 decreases, the height of optic element 108 decreases. Since for many applications the size of an illumination assembly is constrained by certain standards such as ANSI C78. 21-2003, conforming to the volume and size standards is all the more required to fit the multi chip LED illumination assembly into replacement lamp designs for existing lamp fixtures.

Moreover, the temperature distribution on the substrate 102 and the temperature of the individual LEDs themselves depends on a number of factors, including the number of LEDs, their location on the substrate 102, the thermal resistance associated with mounting the LED die to the substrate and the design of the heat sink (not shown in FIGS. 1 and 2). In particular, as is well known in the art, the thermal resistance between the LED die and the substrate must be minimized to allow heat transfer and keep the LEDs from getting too warm. Furthermore, if the temperature of the LEDs becomes too high, their efficiency goes down and lifetime is reduced.

The size of the single optic element is constrained by the requirements set in the standards. This leads to a limitation of the maximum diameter of the light emitting area and consequently limits the number of light emitting diodes allowed to be placed in a light emitting area because of assembly and thermal constraints.

Several identical illumination assemblies of the type illustrated in FIGS. 1 and 2 can be mounted side by side on a larger mounting surface. This approach suffers from several limitations including, increased part count, increased component cost and increased assembly costs.

### Description of Exemplary Embodiments of the Present Invention

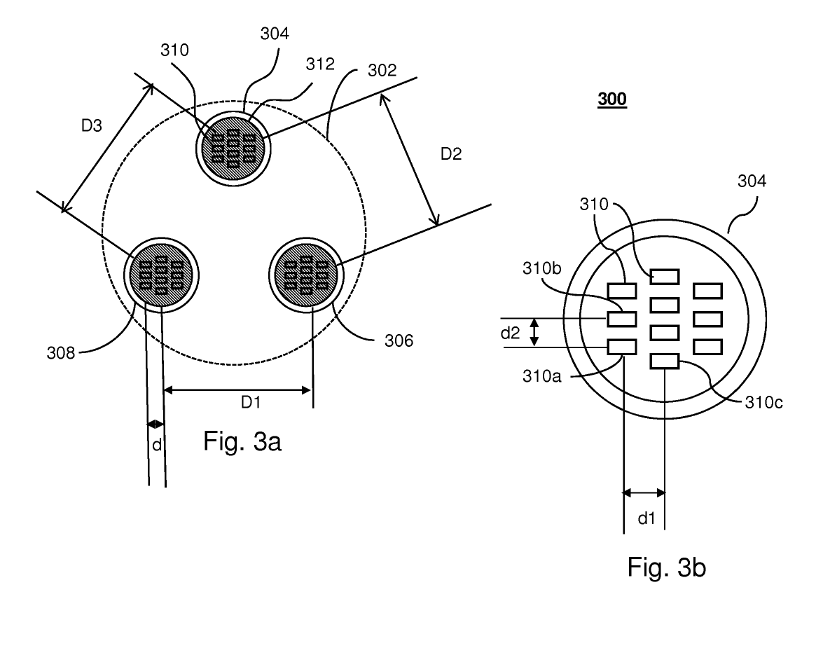

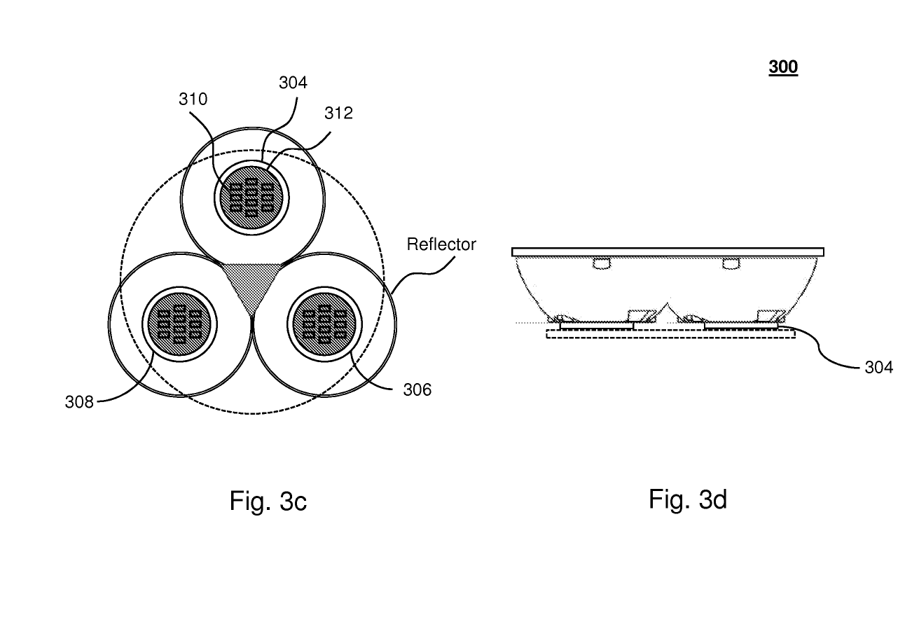

Moving on, there is shown in FIG. 3a, a diagrammatic illustration of an arrangement of semiconductor die of an illumination assembly 300 in accordance with an exemplary embodiment of the present invention. As illustrated in FIG. 3a, the arrangement of the semiconductor die of the illumination assembly 300 includes a single substrate 302 that further includes three light emitting areas 304, 306 and 308. The description of the figure will be with reference to the light emitting area 304. However, it will be readily apparent to those skilled in the art that the light emitting areas 306 and 308 function in a substantially similar manner. Also, it should be appreciated that, even though the number of light emitting areas in the figure has been shown to be three, in other embodiments of the invention, the number of the light emitting areas is not restricted to three and can be any number greater than one and preferably less than eight, without deviating from the scope of the invention. The light emitting area 304 includes multiple semiconductor dies 310 directly mounted over the substrate 302. Each light emitting area 304, 306 and 308 is separated from another light emitting area by a first distance ‘D’ for example light emitting areas 306 and 308 are separated by distance ‘D1’, light emitting areas 306 and 304 are separated by distance ‘D2’ and light emitting areas 304 and 308 are separated by distance ‘D3’. In accordance with an embodiment of the present invention, the distances ‘D1’, ‘D2’ and ‘D3’ may vary in accordance with an arrangement of the light emitting areas 304, 306 and 308. The arrangement of the light emitting areas 304, 306 and 308 can be circular, triangular, rectangular, hexagonal or in any other desired arrangement without deviating from the scope of invention. Further, each semiconductor die 310 is being separated by a second distance ‘d’. The second distance ‘d’ may vary according to an arrangement of the semiconductor dies 310. The semiconductor dies 310 within each light emitting area 304, 306 and 308 can be arranged in circular, triangular, rectangular, hexagonal or in any other desired arrangement without deviating from the scope of invention.

In an embodiment of the present invention, the semiconductor dies 310 are directly mounted over the substrate 302. Consequently, an extra layer of (intermediate) substrate present in the conventional LED based illumination assembly is removed and the thermal resistance of the illumination assembly is reduced. This important reduction in thermal resistance improves the overall thermal design of LED based illumination assembly, for example, by allowing for smaller heat sinks to be used. Moreover, the height of the illumination assembly is also reduced by removing the extra layer of the substrate. Furthermore, the complexity of assembly and number of electrical interconnections are also reduced.

In an embodiment, the substrate 302 can be made of a material having high thermal conductivity, for example, thermal conductivity may range from 10 to 400 Watt/(m·K). The substrate 302 can be formed from a single metal plate which provides heat dissipation and also rigidity to the illumination assembly 300. Examples of the substrate 302 include, but are not limited to metals such as aluminum, copper, brass, nickel, steel and various common metal and alloys thereof. The substrate 302 also includes conducting traces (not shown in FIG. 3) directly attached by wire bonding or other means to the semiconductor dies to provide electric current to the die and are electrically isolated from the substrate. Those ordinarily skilled in the art will appreciate that the material of the substrate is not limited to those mentioned above and can include other such material having high thermal conductivity. The substrate may also include more than one material, for example a combination of ceramic and metal, or it may be formed from a printed circuit board with metal regions for heat conduction and metal traces providing electrical connections.

Moving on, in an embodiment, a phosphor layer 312 may be spread over the semiconductor dies 310 as shown in FIG. 3a and in another embodiment, may be optionally omitted. The phosphor layer 312 can be spread using various methods, and it should be appreciated that a method of spreading the phosphor layer 312 does not limit the scope of the present invention.

The phosphor layer 312 is usually provided in order to enable wavelength conversion of the light being emitted by the multiple LEDs. In real life applications, the color of light emitted by the LEDs is usually blue with a yellow phosphor layer 312. However, those ordinary skilled in the art will appreciate that the color of the light emitted by the LEDs is not limited to blue. Further, light emitted from the light emitting areas 304, 306 and 308 may be of same or different color for example light emitting area 304 can be blue, light emitting area 306 can be green, light emitting area 308 can be red etc. However, it should be appreciated that the color of light being emitted by the light emitting areas is not restricted to those mentioned here and can be any other color without deviating from the scope of the invention.

Further in another embodiment the layer of phosphor 312 can be spread over the semiconductor dies 310 placed on the light emitting areas 304, 306 and 308.

The phosphor layer 312 absorbs ultraviolet and/or visible light spectrum emitted by semiconductor dies 310 and emits broadband visible emission. Color and luminance of the light emitted remains the same with temperature because of a temperature stable crystal structure of the phosphor. In one embodiment, the phosphor is Cerium (III)-doped YAG (Yttrium Aluminum Garnet) which has a broad emission peaked in the yellow portion of the spectrum. In another embodiment, SiAlONs can serve as phosphor. However, in other embodiments, a green and a yellow SiAlON phosphor and a red CaAlSiN3-based (CASN) phosphor can also be used. Those ordinary skilled in the art will appreciate that a variety of other phosphor materials can be used.

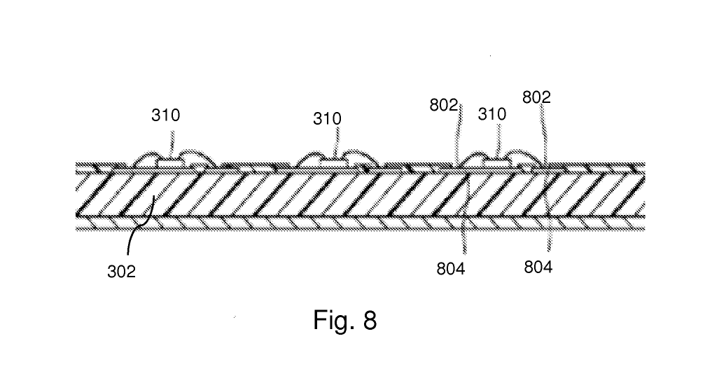

Moving on, each of the die of the multiple semiconductor dies 310 can include a pair of electrical contacts (not shown in FIG. 3) i.e. electrical terminals or electrodes (anode and cathode). Further, each of the electrodes is electrically coupled to the respective light emitting areas (light emitting area 304 in this case). In accordance with an embodiment of the present invention, each electrical contact of the semiconductor dies 310 can be electrically coupled, by wire bonding or other means, to an electric connection. Further, a number of insulated conducting traces are placed over the substrate 302, resulting in individual connections to the semiconductor dies 310. The traces are wired together in parallel or in series or in combination thereof. Thereafter as soon as a current is provided to the circuit, all the multiple semiconductor dies 310 of the light emitting area 304 glow simultaneously resulting in emission of light. An illustration of a layered structure of the substrate 302 with the semiconductor dies 310, conductive traces 804, and wire bonding 802 in accordance with an embodiment of the invention, has been provided in FIG. 8. The multiple semiconductor dies 310 shown in FIG. 8 belong to one light emitting area 304. Other light emitting areas 306 and 308 can have a similar structure with all light emitting areas 304, 306 and 308 sharing a common substrate 302.

Moving on, the enlarged view of the light emitting area 304 is shown in FIG. 3b. The light emitting area 304 having multiple semiconductor dies 310 is shown in the FIG. 3b. The semiconductor die 310 can be arranged in a two dimensional array, as shown in FIG. 3b, in a circular pattern, or triangular, rectangular, hexagonalor in any other desired arrangement without deviating from the scope of invention. A semiconductor die in the multiple semiconductor dies 310 is separated from an adjacent semiconductor die by the second distance represented by ‘d’. The semiconductor dies can be separated by an equal distance in the same light emitting area 304, 306 and 308, for example, with reference to x axis a die 310a and an adjacent die 310c are separated by distance ‘d1’ and with reference to y axis the die 310a and an adjacent die 310b are separated by distance ‘d2’. In an embodiment, the distances d1 and d2 can be same or different to achieve desired lighting. Preferably, the distances d1 and d2 can range from a minimum of 1 mm to a maximum of 5 mm.

Further, in another embodiment of the present invention, the first distance separating any two of the light emitting areas 304, 306 and 308 is for example ‘D1’, ‘D2’ and ‘D3’, and the second distance separating any two adjacent semiconductor dies of the multiple semiconductor dies 310 of the same light emitting area is for example ‘d1’ and ‘d2’. In accordance with an embodiment of the invention the first distance D (or D1, D2 and D3) is substantially greater than the second distance d (or d1, d2 and d3). In an embodiment, the distances D1, D2 and D3 can be the same distance ‘D’.

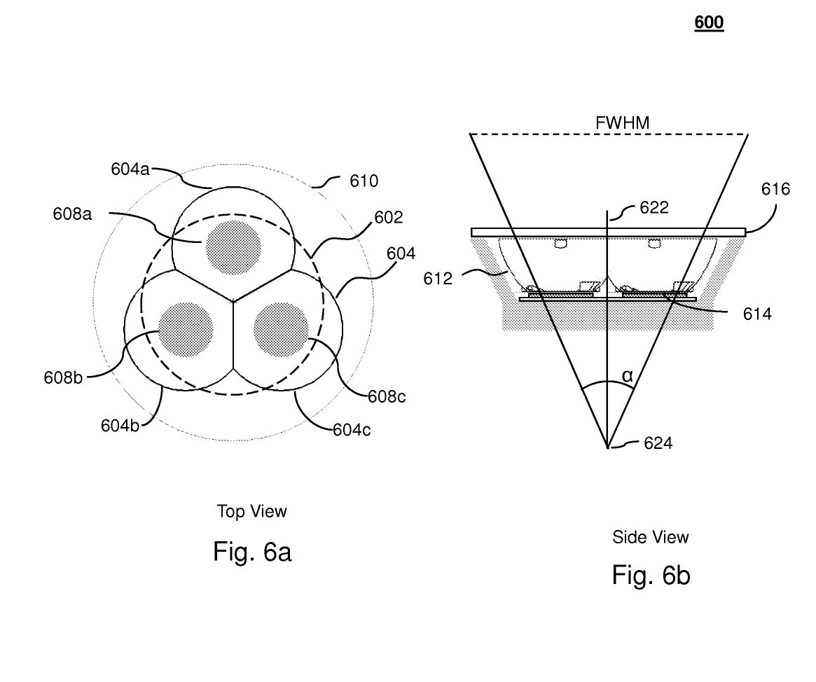

In an embodiment, the first distance D can be greater than 1.5 times of a diameter of the plurality of light emitting areas 304, 306 and 308 and less than 6 times of the diameter of the plurality of light emitting areas 304, 306 and 308. For example, if diameter of the light emitting areas 304, 306 and 308 is 10 mm then the first distance ranges from 15 mm to 60 mm and the second distance ranges from 1 mm to 5 mm. Moving on, there is shown in FIGS. 3c and 3d an exemplary top view and a side view of an illumination assembly, in accordance with an embodiment of the present invention. The arrangement of the semiconductor dies in the illumination assembly of FIG. 3c is similar to that in FIG. 3a. Further details relating to the structure and shape of the elements illustrated in FIGS. 3c and 3d will be explained in relation with FIGS. 6a and 6b.

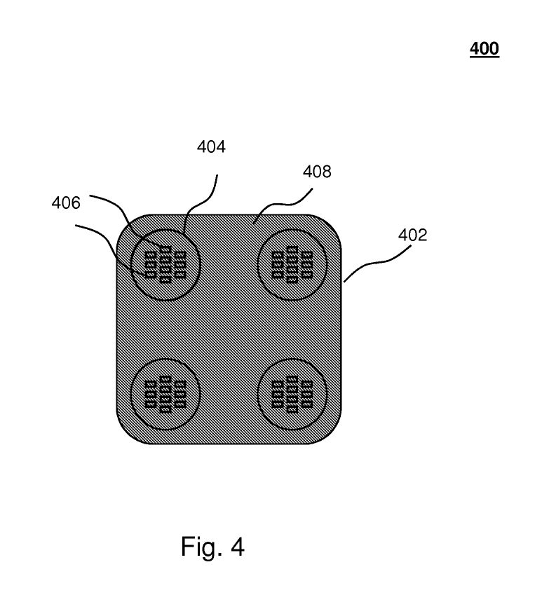

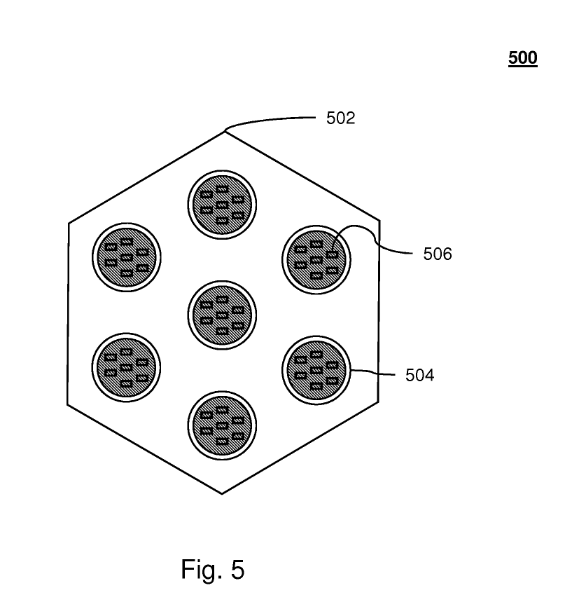

In another embodiment of the present invention, there is shown in FIG. 4 an exemplary view of arrangement of semiconductor dies of an illumination assembly 400. The arrangement of semiconductor dies of the illumination assembly 400 is similar to the arrangement of semiconductor dies of the illumination assembly 300, a difference being that the arrangement of semiconductor dies of illumination assembly 400 includes four light emitting areas in contrast to three light emitting areas in the arrangement of semiconductor dies of illumination assembly 300. Also, phosphor layer 408 is shown to cover the entire substrate 402 instead of covering only the light emitting area(s) 404. In yet another embodiment (not shown), there is a single contiguous phosphorregion that covers multiple light emitting areas 404 but does not cover the entire substrate area 402.

Moving on to FIG. 5, another exemplary embodiment of the present invention is illustrated, an arrangement of semiconductor dies of illumination assembly 500 having a hexagonal substrate 502 is shown. It should be noted that the arrangement of semiconductor dies of illumination assembly 500 is similar in nature and characteristics to the arrangement of semiconductor dies of illumination assembly 300 and the arrangement of semiconductor die of illumination assembly 400, a difference being that the arrangement of semiconductor dies of illumination assembly 500 is shown to include seven light emitting areas in contrast to three and four light emitting areas in the arrangement of semiconductor dies of illumination assembly 300 and the arrangement of semiconductor dies of illumination assembly 400 respectively.

Those ordinary skilled in the art will appreciate that the substrate can be of any other regular polygonal or any other shape to obtain a desired lighting. Also, the phosphor layer can be disposed over the whole substrate, on the light emitting areas or any other combination of light emitting area only without deviating from the scope of the invention.

In different embodiments of the present invention the number of light emitting areas may be different. Preferably the number of light emitting areas in accordance of the present invention can be more than two and further preferably, less than eight. However, it should be appreciated that, the number of light emitting areas in accordance with the invention is not restricted to the range mentioned above and can be any number more than one without deviating from the scope of the invention.

In another embodiment of the present invention, a design according to the present invention can utilize closely packaged light-emitting areas, as shown in FIGS. 6a and 6b. A top view and a side view respectively; of an illumination assembly 600 are shown in the FIGS. 6a and 6b.

The illumination assembly 600 shown in FIG. 6a includes a substrate 602 having a high thermal conductivity. It should be noted that the arrangement of semiconductor dies of the illumination assembly 600 is similar in nature and characteristics to the arrangement of semiconductor dies of the illumination assembly 300, 400 and 500. However, in the illustrated embodiment, a single piece optic element 604 made of multiple segments (as visible in FIG. 6b) corresponding to different light emitting areas 608a, 608b and 608c is provided.

The single piece optic element 604 can be provided integrally on the light emitting areas 608a, 608b and 608c. The single piece optic element 604 functions to converge and direct rays of light emitted from the light-emitting area 608a, 608b and 608c. The single piece optic element 604 includes light directing sections 604a, 604b and 604c corresponding to each light emitting area 608a, 608b and 608c. The light directing sections 604a, 604b and 604c encompass one to one correspondence with each other and direct the light emitted from each light emitting area 608a, 608b and 608c into a cone of light. As shown in FIGS. 6a and 6b, light directing sections 608a, 608b and 608c are reflective curved minors. However, as is well known in the art, the single piece optic element 604 may have optical surfaces that are reflective, refractive or scattering to direct light. The light beam directed by the single piece optic element 604 harmonizes into a symmetric cone of light at a distance of approximately less than 0.5 meters. The cone of light has been illustrated and described in detail in association with FIG. 6b. Moreover, the height of the illumination assembly 600 is substantially equal to the height of the single piece optic element 604.

In some embodiments of the present invention, the height of the optic element 604 can be inversely proportional to the square root of the number of light emitting areas 608a, 608b and 608c. In an embodiment of the present invention, if the number of light emitting areas 608a, 608b and 608c is N, then the height of the optic element 604 is proportional to 1/N^{1/2}. For example, as disclosed earlier in association with FIGS. 1 and 2, the height of optic element 604 with single light emitting area was 38 mm and with three light emitting areas 608a, 608b and 608c. Whereas for the case N=3, according to the present invention the height of the optic element would be approximately 22 mm and, for the case of N=7, the height would approximately 14 mm.

In accordance with an embodiment of the present invention, the single piece optic element 604 can be made by integrating multiple segments, for example in real life applications, if there are three light emitting areas 608a, 608b and 608c, then three optic elements can be integrated with each other to form a single piece optic element 604, thereby reducing size of the single piece optic element 604 in a lateral direction as compared to three separate and distinct optic elements. The single piece optic element 604 includes light directing sections 604a, 604b and 604c for each light emitting area 608a, 608b and 608c. The light emitted from each light directing section 604a, 604b and 604c intensifies into one single light beam, preferably the cone of light. Further, this single piece optic element 604 can also be molded, for example the single piece optic element 604 may be made by an injection molding process. However, it should be appreciated that other suitable molding process may also be used for this and scope of the invention is not limited by a molding process.

In an embodiment, the single piece optic element 604 is made of a plastic material, for example, but not limited to, polycarbonate, acrylic and polystyrene. Furthermore, the single piece optic element has a metal coating, such as aluminum. However, those ordinary skilled in the art will appreciate that the material of the single piece optic element 604 is not limited to the material mentioned above and can include other similar material that provide light reflecting and/or refracting properties.

In simpler words, an illumination assembly according to the present invention includes a high thermally conducting substrate. Further, the substrate has two or more light emitting areas disposed on the substrate, such that, each light emitting area is formed of a plurality of semiconductor dies. Furthermore, all the light emitting areas combined together include an integrated optic element disposed over them, such that light emitted by the plurality of semiconductor dies in each light emitting area can be focused and directed as a cone of light. The invention is characterized such that the thermal resistance of the illumination assembly is reduced along with the height of the optic element of the illumination assembly. The height of the optic element is inversely related to the number of light emitting areas, i.e. more the number of light emitting areas lesser is the height of the optic element. This enables formation of a lighting device that provides a higher luminous intensity than conventionally available devices and at the same time abides by standards of volume and size for such devices.

As shown in FIG. 6b, the illumination assembly 600 includes an optional transparent window 616, which is provided on single piece optic element 612. The dense packing allows easier integration of the illumination assembly 600 into a form factor of existing standard lamps, as described for example in ANSI C78.21-2003. Moreover, light originating from densely packed light emitting areas can be more easily mixed into a light beam, preferably a cone of light. The illumination assembly 600 produces the cone of light having an apex 624, an axis 622 and a cone angle ‘α’. Preferably, the cone of light is substantially symmetric about the axis 622. The cone of light contains light emitted from all of the light emitting areas 608 (shown in FIG. 6a). Preferably, the integrated light forms the cone having the angle ‘α’ of less than 70 degrees full width at half maximum (FWHM) of the beam. The FWHM parameter is defined as the divergence angle at half the maximum light intensity. Finally, the resulted light emanates from the transparent window 616 of the illumination assembly 600.

The transparent window 616 functions to protect the illumination assembly 600. Furthermore, the transparent window 616 covers the optic element 608 and encapsulates the illumination assembly 600 and can include various optical features for modifying the light distribution. For example, the transparent window 616 may include a Fresnel lens for further collimating the emitted light or a scattering layer for diffusing the emitted light. Those ordinary skilled in the art will appreciate that shape of the transparent window is not limited to a flat plate type (as illustrated) only. For example it may be curved or dome shaped.

As shown in the figures, a high packing density of the light emitting areas can provide a higher average luminance and reduce the overall thermal resistance and height of the illumination assembly 600. As a result the illumination assembly 600 can be more compact, require fewer and smaller optical components and can achieve better emission and higher luminance within the same size when compared to conventional systems. Thus the dense packing allows easier integration of the illumination assembly 600 into a form factor of existing standard lamps. Moreover, light originating from densely packed different light emitting areas can be more easily mixed into a light beam, preferably a cone of light. For example, in real life applications, if the illumination assembly 600 of the present invention emits three different lights of red, green and blue colors, then these three lights can be easily combined and mixed in a better manner in comparison to the red, green and blue light beams emitted by a prior art device.

In real life applications, the illumination assembly according to the present invention includes a high thermally conducting substrate. Further, the substrate is provided with two or more light emitting areas disposed on the substrate, such that, each light emitting area is formed of a plurality of dies. Further, a phosphor layer is provided over the dies. Furthermore, the light emitting area are provided with an integrated single piece optic element, such that light emitted by the plurality of dies can be directed as a cone of light. The cone of light is substantially symmetric about an axis of said cone. The invention is characterized such that the height of the single piece optic element of the illumination assembly is inversely related to the number of light emitting areas, i.e. more the number of light emitting areas lesser is the height of the optic element. This enables formation of a lamp that provides a higher luminous intensity than conventionally available devices and at the same time abides by standards of volume and size for such devices.

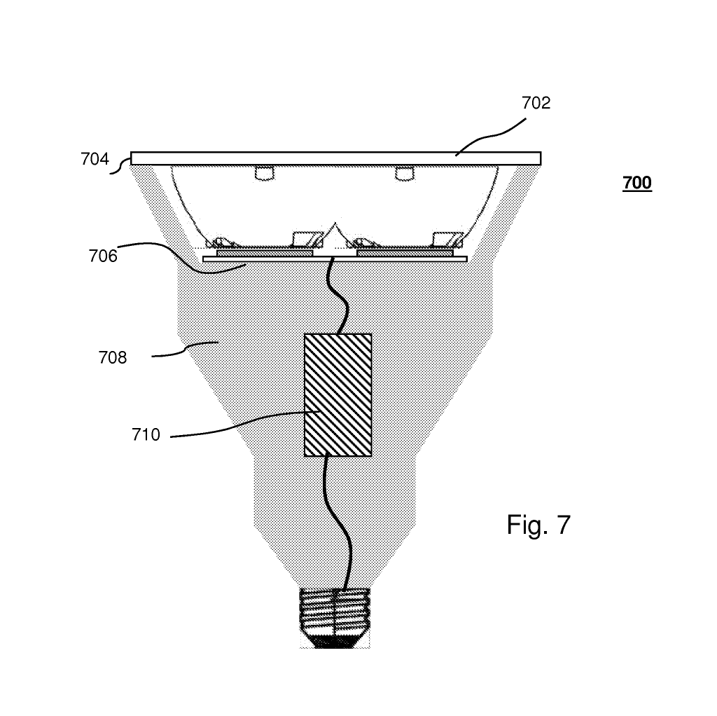

In another embodiment of the present invention, a lamp 700, based on the illumination assembly described above, is illustrated in FIG. 7. In an embodiment, the lamp 700 can be a down-light lamp. The lamp 700 is shown to include the elements of an illumination assembly as disclosed in earlier figures. Also, disclosed are a current driver 710 connected to a substrate 706 and a base (not numbered) that provides the lamp 700 with a standard connection such as ANSI C78.21-2003 to lighting sockets.

Typically, the driver 710 converts AC household electrical power to lower-voltage DC current and provides the DC current to the semiconductor dies that are disposed on the substrate 706. Voltage is applied such that a light output characteristic of the lamp 700 can be maintained. In one embodiment, the light output intensity of the lamp 700 can be maintained at an average predetermined light output level, typically ranging from a few hundred to a few thousand lumens. Further, heat generated by the lamp 700 is transferred to a heat sink 708 evenly, and is then dispersed to ambient air efficiently and rapidly. In an embodiment, the heat sink 708 can be made of a metal such as aluminum, aluminum alloy, copper or other common metals. Furthermore, thanks to the reduced volume of the single piece optical element, the heat sink 708 and driver 710 may occupy a larger fraction of the total lamp 700 volume than prior art devices.

Various embodiments, as described above, provide an illumination assembly and a lamp based on the illumination assembly that has several advantages. One of the several advantages of some embodiments of this invention is that it increases the luminous efficiency of the light emitting illumination assembly and lamp. Another advantage of this embodiment is that the height and total volume of the illumination assembly is reduced. Yet another advantage provided by the illumination assembly of the present invention is that it is cost-effective compared to the prior art devices, because of its compact size, easily manufactured molded optic elements, simple assembly process and low part count.

While the invention has been disclosed in connection with the preferred embodiments shown and described in detail, various modifications and improvements thereon will become readily apparent to those ordinarily skilled in the art. Accordingly, the spirit and scope of the present invention is not to be limited by the foregoing examples, but is to be understood in the broadest sense allowable by law.

All documents referenced herein are hereby incorporated by reference.

1. An illumination assembly comprising:
a substrate having a plurality of light emitting areas disposed on said substrate, said plurality of light emitting areas being separated by at least a first distance, wherein each light emitting area of said plurality of light emitting areas has a plurality of semiconductor dies directly mounted on said substrate, each semiconductor die of said plurality of semiconductor dies being separated by at least a second distance, wherein said first distance is substantially greater than said second distance, further wherein direct mounting of said semiconductor dies on said substrate reduces at least one of a thermal resistance and a height of said illumination assembly; and
a single piece optic element disposed over said plurality of light emitting areas on said substrate, said single piece optic element being configured to direct light emitted from said plurality of light emitting areas in a cone of light.

2. The illumination assembly according to claim 1 further comprising a phosphor layer placed over at least said plurality of semiconductor dies.

3. The illumination assembly according to claim 1, wherein said first distance is greater than 1.5 times of a diameter of said plurality of light emitting area and less than 6 times of said diameter of said plurality of light emitting area.

4. The illumination assembly according to claim 1, wherein said second distance in the same light emitting area ranges from 1 mm to 5 mm.

5. The illumination assembly according to claim 1, wherein said height of said single piece optic element is inversely related to a square root of a number of said plurality of light emitting areas.

6. The illumination assembly according to claim 1, wherein said single piece optic element is molded.

7. The illumination assembly according to claim 1, wherein said light emitted from each light emitting area of said plurality of light emitting areas is of one or more colors.

8. The illumination assembly according to claim 1, wherein said substrate is of a material having a high thermal conductivity.

9. The illumination assembly according to claim 1 further comprising a transparent window placed substantially over said illumination assembly, whereby encapsulating said illumination assembly.

10. The illumination assembly according to claim 1, wherein said single piece optic element comprises a plurality of light-directing sections, said plurality of light-directing sections having a one-to-one correspondence to said plurality of light emitting areas.

11. The illumination assembly according to claim 1, wherein said cone of light is substantially symmetric about an axis of said cone.

12. The illumination assembly according to claim 1, wherein an angle of said cone of light is less than 70 degrees full-width at half-maximum.

13. The illumination assembly according to claim 1, wherein said plurality of light emitting areas comprise at least 3 and at most 7 light emitting areas.

14. The illumination assembly according to claim 1, wherein an array of said plurality of light emitting areas forms a polygon.

15. The illumination assembly according to claim 1, wherein said substrate is formed from a single metal plate and further includes conducting traces for providing electrical current to said plurality of semiconductor dies.

16. A lamp comprising:
a substrate having a plurality of light emitting areas disposed on said substrate, said plurality of light emitting areas being separated by at least a first distance, wherein each light emitting area of said plurality of light emitting areas has a plurality of semiconductor dies directly mounted on said substrate, each semiconductor die of said plurality of semiconductor dies being separated by at least a second distance, wherein said first distance is substantially greater than said second distance;
a single piece optic element disposed over said plurality of light emitting areas on said substrate, said single piece optic element being configured to direct light emitted from said plurality of light emitting areas in a cone of light, wherein said plurality of light emitting areas enable reduction in at least one of a thermal resistance and a height of said single piece optic element;
a current driver connected to said substrate and providing a controlled flow of current to said plurality of semiconductor dies; and
a heat sink capable of dissipating heat.

17. An illumination assembly comprising:
a substrate having a plurality of light emitting areas disposed on said substrate, said plurality of light emitting areas being separated by at least a first distance, wherein each light emitting area of said plurality of light emitting areas has a plurality of semiconductor dies directly mounted on said substrate, each semiconductor die of said plurality of semiconductor dies being separated by at least a second distance, wherein said first distance is substantially greater than said second distance;
a single piece optic element disposed over said plurality of light emitting areas on said substrate, said single piece optic element being configured to direct light emitted from said plurality of light emitting areas in a cone of light, wherein a height of said single piece optic element is inversely related to square root of a number of said plurality of light emitting areas;
a transparent window substantially placed over said single piece optic element, wherein said transparent window encapsulates said single piece optic element;
a current driver connected to said substrate and providing a flow of current to said plurality of semiconductor dies; and
a heat sink capable of dissipating heat.
